(19) United States
(12) Patent Application Publication
(10) Pub. No.: US 2024/0184122 A1
(43) Pub. Date: Jun. 6, 2024

(54) Display System Circuitry

(71) Applicant: Apple Inc., Cupertino, CA (US)

(72) Inventors: Christopher Patton, San Jose, CA (US); Michael J. Oudenhoven, San Francisco, CA (US); Rick Y. Huang, Sunnyvale, CA (US)

(21) Appl. No.: 18/444,151

(22) Filed: Feb. 16, 2024

Related U.S. Application Data
(63) Continuation of application No. PCT/US22/42469, filed on Sep. 2, 2022.
(60) Provisional application No. 63/298,556, filed on Jan. 11, 2022.
(60) Provisional application No. 63/246,746, filed on Sep. 21, 2021.

(51) Int. Cl. G02B 27/01

(52) U.S. Cl. CPC G02B 27/0176; G02B 2027/0138; G02B 2027/0178

(57) ABSTRACT

A head-mounted device may have projectors that provide images. Waveguides in lenses may be used in conveying the images to eye boxes. A head-mounted frame in the head-mounted device may have lens openings that receive the lenses. The frame may include a frame member such as an elongated metal member that extends across the frame above the left and right lenses. The frame may include frame structure such as polymer structures that cover the frame member and that are configured to form the lens openings. The frame member may have a cable channel. Cabling may be used to route signals between the projectors, strain gauge circuitry, control circuitry, and other circuits in the head-mounted device. The cabling may be received within the cable channel and encapsulated in a protective polymer. Additional polymer may be molded over the protective polymer to form the frame.

This application is a continuation of international patent application No. PCT/US2022/042469, filed Sep. 2, 2022, which claims priority to U.S. provisional patent application No. 63/298,556, filed Jan. 11, 2022, and U.S. provisional patent application No. 63/246,746, filed Sep. 21, 2021, which are hereby incorporated by reference herein in their entireties.

### FIELD

This relates generally to electronic devices, and, more particularly, to electronic devices such as head-mounted devices.

### BACKGROUND

Electronic devices such as head-mounted devices may have displays for displaying images. The displays may be housed in a head-mounted support structure.

### SUMMARY

A head-mounted device may have projectors that provide images. The head-mounted device may have left and right lenses. Waveguides in the lenses may be used in conveying the images from the projectors to eye boxes for viewing by a user.

A head-mounted frame in the head-mounted device may have lens openings that receive the lenses. The frame may include a frame member such as an elongated metal member (sometimes referred to as an elongated frame portion) that extends across the frame above the left and right lenses. The frame may also include frame structures such as polymer structures that cover the frame member and that form the lens openings.

The head-mounted device may include batteries, control circuitry, input-output devices such as speakers, sensors, projectors, and cameras, and/or other circuits. Signals such as camera and display signals and other signals associated with operating the head-mounted device may be routed over cabling in the device. The cabling may include a bundle of coaxial cables for handling high bandwidth data (e.g., video).

The frame member may have a cable channel. A cable such as a cable formed from a bundle of coaxial cables that is used to route signals between the projectors, strain gauge circuitry, control circuitry, and other circuits in the head-mounted device may be received within the cable channel.

Protective polymer may cover the cabling. For example, protective polymer may be formed in the cable channel so that the cabling is embedded within the protective polymer. If desired, some of the protective polymer (e.g., protective polymer structures in a central portion of the frame) may cover sensitive circuitry such as strain gauge circuitry. After the protective polymer has been formed, additional polymer may be molded over the protective polymer to form the frame.

### BRIEF DESCRIPTION OF THE DRAWINGS

FIG. 1 is a schematic diagram of an illustrative electronic device such as a head-mounted display device in accordance with an embodiment.

FIG. 2 is a top view of an illustrative head-mounted device in accordance with an embodiment.

FIG. 3 is a rear perspective view of the underside of a head-mounted device in accordance with an embodiment.

FIG. 4 is a circuit diagram of illustrative circuitry for a head-mounted device in accordance with an embodiment.

FIG. 5 is a diagram of illustrative head-mounted device circuits and an illustrative frame member to which the circuits may be coupled in a head-mounted device in accordance with an embodiment.

FIG. 6 is a diagram of an illustrative head-mounted device in accordance with an embodiment.

FIG. 7 is a perspective view of a portion of an illustrative head-mounted device frame member with a cable routing recess in accordance with an embodiment.

FIGS. 8, 9, 10, and 11 are cross-sectional side views of the head-mounted device frame member of FIG. 7 showing how a cable may be mounted within the cable routing recess in accordance with an embodiment.

FIG. 12 is a diagram of an illustrative strain gauge sensor in accordance with an embodiment.

FIG. 13 is a diagram of an illustrative system-in-package device (system-in-package) that may be used in forming a strain gauge sensor in accordance with an embodiment.

### DETAILED DESCRIPTION

Electronic devices such as head-mounted devices may include displays and other components for presenting content to users. A head-mounted device may have head-mounted support structures that allow the head-mounted device to be worn on a user's head. The head-mounted support structures, which may sometimes be referred to as a head-mounted support, may support optical components such as displays for displaying visual content and front-facing cameras for capturing real-world images. In an illustrative configuration, optical components such as waveguides may be used to provide images from display projectors to eye boxes for viewing by a user.

The head-mounted device may have sensors. For example, a strain gauge sensor may be used to monitor for potential deformation of the support structures (e.g., twisting, bending, etc.). Deformation of the support structures (e.g., deformation of a glasses frame member or other head-mounted support structure due to excessive force such as force from a drop event) may potentially lead to optical component misalignment and image distortion. By monitoring for frame bending and other support structure deformations using strain gauge sensor circuitry, corrective actions may be taken to prevent undesired image distortion. For example, digital image warping operations may be performed on digital image data being provided to the projectors and/or other actions may be taken to compensate for the deformation. In this way, the head-mounted device may compensate for the measured support structure deformation.

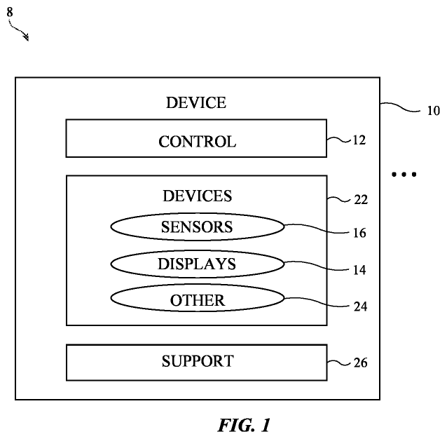

A schematic diagram of an illustrative system that may include a head-mounted device is shown in FIG. 1. As shown in FIG. 1, system 8 may include one or more electronic devices such as electronic device 10. The electronic devices of system 8 may include computers, cellular telephones, head-mounted devices, wristwatch devices, and other electronic devices. Configurations in which electronic device 10 is a head-mounted device are sometimes described herein as an example.

As shown in FIG. 1, electronic devices such as electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involving the adjustment of the components of device 10 using control signals, etc.). Control circuitry 12 may include wired and wireless communications circuitry. For example, control circuitry 12 may include radio-frequency transceiver circuitry such as cellular telephone transceiver circuitry, wireless local area network transceiver circuitry (e.g., WiFi® circuitry), millimeter wave transceiver circuitry, and/or other wireless communications circuitry.

During operation, the communications circuitry of the devices in system 8 (e.g., the communications circuitry of control circuitry 12 of device 10), may be used to support communication between the electronic devices. For example, one electronic device may transmit video data, audio data, and/or other data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Device 10 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 1, input-output devices 22 may include one or more displays such as displays 14. In some configurations, device 10 includes left and right display devices (e.g., left and right components such as left and right projectors based on scanning mirror display devices, liquid-crystal-on-silicon display devices, digital mirror devices, or other reflective display devices, left and right display panels based on light-emitting diode pixel arrays (e.g., organic light-emitting display panels or display devices based on pixel arrays formed from crystalline semiconductor light-emitting diode dies), liquid crystal display panels, and/or or other left and right display devices that provide images to left and right eye boxes for viewing by the user's left and right eyes, respectively. Illustrative configurations in which device 10 has left and right display devices such as left and right projectors that provide respective left and right images for a user's left and right eyes may sometimes be described herein as an example.

Displays 14 are used to display visual content for a user of device 10. The content that is presented on displays 14 may include virtual objects and other content that is provided to displays 14 by control circuitry 12. This virtual content may sometimes be referred to as computer-generated content. Computer-generated content may be displayed in the absence of real-world content or may be combined with real-world content. For example, an optical coupling system may be used to allow computer-generated content to be optically overlaid on top of a real-world image. In particular, device 10 may have a see-through display system that provides a computer-generated image to a user through a beam splitter, prism, holographic coupler, diffraction grating, or other optical coupler (e.g., an output coupler on a waveguide that is being used to provide computer-generated images to the user) while allowing the user to view real-world objects through the optical coupler and other transparent structures (e.g., transparent waveguide structures, vision-correction lenses and/or other lenses, etc.).

Input-output circuitry 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors, sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), strain gauge sensors, and/or other sensors.

User input and other information may be gathered using sensors and other input devices in input-output devices 22. If desired, input-output devices 22 may include other devices 24 such as haptic output devices (e.g., vibrating components), light-emitting diodes and other light sources, speakers such as car speakers for producing audio output, circuits for receiving wireless power, circuits for transmitting power wirelessly to other devices, batteries and other energy storage devices (e.g., capacitors), joysticks, buttons, and/or other components.

Electronic device 10 may have housing structures as shown by illustrative support structures 26 of FIG. 1. In configurations in which electronic device 10 is a head-mounted device (e.g., a pair of glasses, goggles, a helmet, a hat, etc.), support structures 26 may include head-mounted support structures (e.g., a helmet housing, head straps, arms or temples in a pair of eyeglasses, goggle housing structures, and/or other head-mounted structures). A head-mounted support structure may be configured to be worn on a head of a user during operation of device 10 and may support displays 14, sensors 16, other components 24, other input-output devices 22, and control circuitry 12.

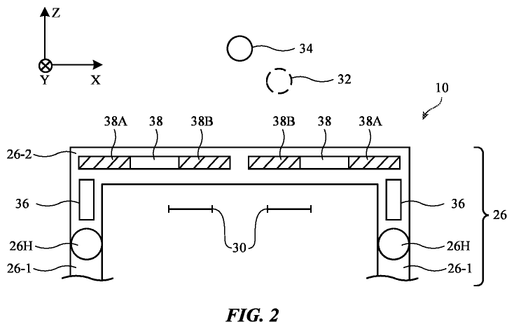

FIG. 2 is a top view of electronic device 10 in an illustrative configuration in which electronic device 10 is a head-mounted device. As shown in FIG. 2, electronic device 10 may include head-mounted support structure 26 to house the components of device 10 and to support device 10 on a user's head. Support structure 26 may include, for example, structures that form housing walls and other structures at the front of device 10 (sometimes referred to as a frame, lens support frame, glasses frame, etc.). In particular, support structure 26 may include support structures 26-2 at the front of device 10, which form glasses frame structures such as a nose bridge, a frame portion that supports left and right lenses with embedded waveguides, and/or other housing structures. Support structure 26 may also include additional structures such as straps, glasses arms, or other supplemental support structures (e.g., support structures 26-1) that help to hold the frame and the components in the frame on a user's face so that the user's eyes are located within eye boxes 30. If desired, support structure 26 may include hinges such as hinges 26H. Support structures 26-1 (which may sometimes be referred to as arms or temples) may be coupled to support structures 26-2 (which may sometimes be referred to as a glasses frame, lens frame, or frame) using hinges 26H (e.g., so that the arms of device 10 can be folded parallel to the frame at the front of device 10 when not in use).

During operation of device 10, images are presented to a user's eyes in eye boxes 30. Eye boxes 30 include a left eye box that receives a left image and a right eye box that receives a right image. Device 10 may include a left display system with a left display 14 that presents the left image to the left eye box and a right display system with a right display 14 that presents the right image to the right eye box. In an illustrative configuration, each display system may have an optical combiner assembly that helps combine display images (e.g., computer-generated image 32 of FIG. 2, sometimes referred to as a virtual image) with real-world image light (e.g., light from real-world objects such as object 34 of FIG. 2). Optical combiner assemblies may include optical couplers, waveguides, and/or other components.

As an example, each display system may have a corresponding projector 36, a waveguide 38, and an optical coupler (e.g., a prism and/or other optical coupling element(s)) to couple an image from the projector into the waveguide from the projector. An output coupler on each waveguide may be used to couple the image out of that waveguide towards a respective eye box after the waveguide has guided the image to a location overlapping the eye box.

In the illustrative configuration of FIG. 2, a left projector 36 may produce a left image and a right projector 36 may produce a right image. Left and right waveguides 38 at the front of device 10 may be provided with left and right optical input couplers 38A that respectively receive the left and right images and couple those images into the left and right waveguides. Waveguides 38 then convey the received images laterally towards the center of device 10 in accordance with the principal of total internal reflection. The left and right images (e.g., computer-generated image 32) are coupled out of the waveguides towards eye boxes 30 using output couplers 38B (e.g., gratings, holographic output couplers, or other suitable output couplers). Output couplers 38B are transparent so that a user may view real-world objects such as object 34 from eye boxes 30.

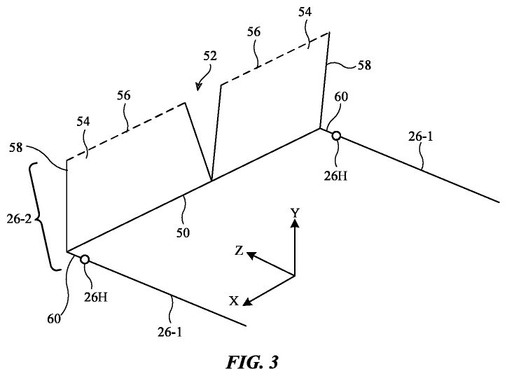

FIG. 3 is a simplified rear perspective view of head-mounted device 10 taken from the underside of device 10. As shown in FIG. 3, support structures 26-1 may be configured to form left and right glasses arms (sometimes referred to as temples or frame supports). The arms of device 10 may be coupled to hinges 26H. When device 10 is being worn on a user's head, the left and right arms of device 10 may extend respectively along the left and right sides of the user's head. Structures 26-2 may include front frame portions such as top frame portion 50 (sometimes referred to as a top frame member, a top frame structure, an upper frame edge support structure, an upper frame support, a top frame support, etc.), which extends from left to right laterally across the top of device 10 when device 10 is being worn by a user. Structures 26-2 may also include left and right side frame portions 58 (sometimes referred to as frame edge members, frame edge structures, edge support structures, frame edge supports, frame supports, etc.) that extend downwards from top frame portion 50 when device 10 is being worn by a user. In the center of device 10, support structures 26-2 may form nose bridge portion 52 (e.g., the glasses frame formed by structures 26-2 may include nose bridge structures that extends downward from top frame member 50 (top frame structure) on the left and right sides of the user's nose when device 10 is being worn on the head of a user). Portions 60 of structures 26-2, which may sometimes be referred to as glasses frame rearward extensions, side housing extensions, end pieces, or temples, may extend rearwardly to hinges 26H from the glasses frame at the front of device 10 that is formed by portion 50, nose bridge portion 52, and side frame portions 58.

Support structures 26-2 may be configured to support left and right glasses lenses 54. Optional lower frame portions 56 may run along the lower edge of each lens 54 to help support the bottom of lenses 54. Lenses 54 may contain embedded waveguides for laterally transporting images from display projectors to locations that overlap eye boxes 30 (FIG. 2), may contain outer and inner optical elements such as protective transparent layers, vision correction lenses, fixed and/or tunable lenses that help establish a desired virtual image distance for virtual image 32, and/or other optical structures (e.g., light modulator layers, polarizer structures, etc.). In an illustrative configuration, device 10 has a left glasses lens with a left waveguide and output coupler (and, if desired, additional structures such as one or more lens elements with associated optical powers) and a right glasses lens with a right waveguide and right output coupler (and, if desired, additional structures such as one or more lens elements with associated non-zero optical powers). The left waveguide and right waveguide may, as an example, each be sandwiched between outer and inner transparent optical structures (e.g., lens elements, protective transparent layers, etc.). During operation, projectors 36 (FIG. 2) may provide left and right images to the left and right waveguides, respectively. The left and right waveguides may respectively guide the left and right images to portions of lenses 54 with output couplers that overlap eye boxes 30, where the output couplers may direct the left and right images to corresponding left and right eye boxes for viewing by the user's left and right eyes.

During use of device 10, device 10 may be subjected to undesirably larger forces (e.g., during drop events). These excessive forces may cause structures 26 to bend or otherwise deform, which could lead to misalignment between the optical components of device 10. Consider, for example, a scenario in which nose bridge portion 52 of structures 26-2 bends about the Y axis of FIG. 3. In this scenario, the left and right images provided to the left and right eye boxes will diverge (or converge) and will not be satisfactorily aligned with eye boxes 30. As another example, consider a scenario in which nose bridge portion 52 is twisted about the X axis. In this scenario, the left image will be provided above its desired position in the left eye box and the right image will be provided below its desired position in the right eye box (as an example). Deformation of structures 26 may also cause the waveguides in device 10 to become misaligned relative to the projectors in device 10. As these illustrative scenarios demonstrate, deformations of structures 26 due to undesired excessive forces may lead to misalignment and potentials for image distortion (image shifting, keystoning, etc.). These image distortion effects can be compensated for digitally by applying compensating image warping to the image data being supplied to the left and right projectors.

Sensor measurements (e.g., using sensors 16) may be used in measuring deformations to structures 26 and/or other sources of optical system misalignment, so that control circuitry 12 can take corrective action. As an example, frame deformations may be measured using strain gauge circuitry mounted in nose bridge portion 52 and/or other areas of the frame. The strain gauge circuitry may include one or more strain gauges (e.g., one or more sets of strain gauge sensor electrodes that exhibit measurable changes in resistance when bent). The strain gauge circuitry may measure support structure deformation (e.g., frame twisting, frame bending, etc.). In an illustrative scenario, which may sometimes be described herein as an example, the frame of device 10 may have an internal support member such as a metal frame member (sometimes referred to as a metal frame structure, internal support, metal internal support, metal frame portion, etc.) to which a strain gauge is attached. Bending and/or twisting may be measured about any suitable dimensions (e.g., about axis X, axis Y, and/or axis Z).

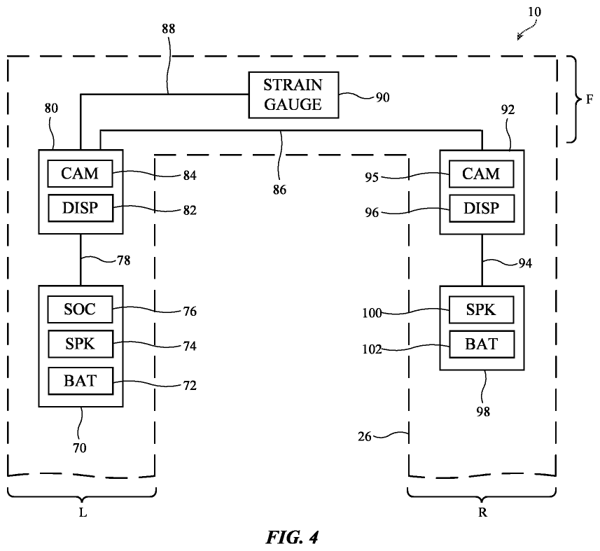

FIG. 4 is a circuit diagram of illustrative circuitry for device 10 that includes a strain gauge for measuring deformations of device 10 (e.g., frame deformations in structures 26-2 of structures 26). As shown in FIG. 4, support structures 26 (e.g., structures forming a head-mounted frame for device 10) may include a left portion L, a right portion R, and a front portion F. Left portion L and right portion R may be formed from portions 60 of structures 26 (FIG. 3). Strain gauge 90 may be located in a central region of front portion F. Other circuitry may be located in left portion L and right portion R. Signal paths 78, 86, 88, and 94 may be used to convey power and data between the circuits of device 10.

As shown in FIG. 4, left portion L may include circuitry 70 and right portion R may include circuitry 98. Circuitry 70 may include control circuitry 12 such as system-on-chip circuit 76 for controlling the operation of device 10. Circuit 76 may include one or more processing integrated circuits, memory, and other control and processing circuitry. Speaker 74 may be located on the left of device 10 in portion L or on a left arm of device 10 and may supply sound to a user's left ear. Speaker 100 of circuitry 98 may be located on the right of device 10 in portion R or on a right arm of device 10 and may supply sound to the user's right car. The speakers in device 10 may play audio received from the control circuitry of device 10 (e.g., music, communications audio, recorded audio, computer-generated alert messages, tones, etc.).

Device 10 may have one or more batteries for supplying power to the circuitry of FIG. 4. In an illustrative configuration, circuitry 70 includes a first battery such as battery 72 and circuitry 98 includes a second battery such as battery 102.

Device 10 may have additional circuitry located at or near front portion F of structures 26 (e.g., at the front of portions 60, in the center of front portion F, etc.). This additional circuitry may include left-side additional circuitry 80 and right-side additional circuitry 92. Circuitry 80 may include left projector display 82 (e.g., the left projector 36 of FIG. 2 or other suitable display 14) and may include forward-facing camera 84. Circuitry 92 may include right projector display 96 (e.g., the right projector 36 of FIG. 2 or other suitable display 14) and forward-facing camera 95.

During operation of device 10, cameras 84 and 95 may capture still and/or moving images and may provide captured image data to the control circuitry of circuit 76. Image data may be viewed on displays in device 10, may be stored for later use, may be transmitted to external equipment using wired and/or wireless signal paths, may be processed (e.g., with object recognition software in device 10), and/or may otherwise be used by the control circuitry of circuit 76.

The control circuitry of circuit 76 may provide image data corresponding to still and/or moving images (e.g., video) to projectors 82 and 96. Projectors 82 and 96 may output corresponding left and right images, respectively, which are provided to eye boxes 30 by the waveguides and other optical systems of device 10.

Strain gauge 90 may measure deformation of structures 26-2 and may provide measurements to the control circuitry of circuit 76. In response to detection of deformation that might lead to optical component misalignment, the control circuitry can perform image warping operations on the image data being supplied to projectors 82 and 96 and/or may otherwise compensate for the misalignment. In this way, image distortion due to deformation of housing 26 and/or other causes of component misalignment can be avoided.

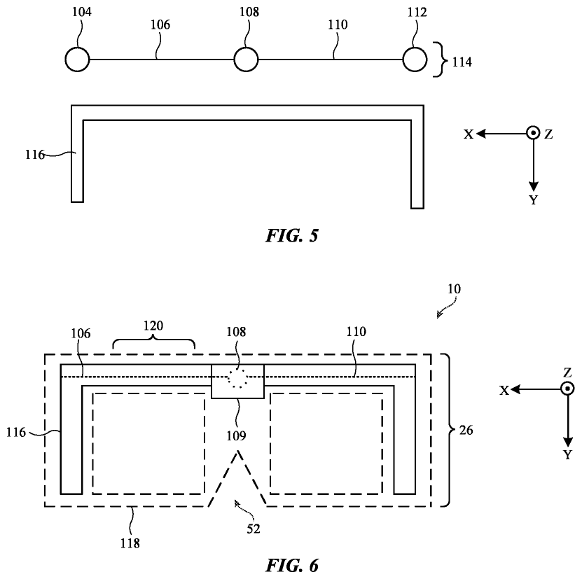

FIG. 5 is a front view of illustrative circuitry and internal supporting structures for device 10. As shown in FIG. 5, the circuitry of device 10 may include illustrative circuits 104, 108, and 112 coupled using signal paths 106 and 110 for forming the circuitry of device 10 (e.g., control circuitry 12, input-output devices 22, etc.). Paths 106 and 110 may include, for example, some or all of the signal paths of FIG. 4 (see, e.g., paths 78, 86, 88, and 94 of FIG. 4). Paths 106 and 110 may be based on any suitable conductive signal lines (e.g., wires, metal traces on flexible printed circuits and/or other substrates, etc.). In an illustrative configuration, some or all of paths 106 and 110 are formed using cables that contain bundles of high-speed wires (e.g., cabling formed from bundles of coaxial cables or other multi-wire cabling). As an example, a coaxial cable bundle for forming paths 106 and/or 110 may include N separate coaxial cables, where the value of N is 20-30, 10-40, less than 50, less than 25, less than 20, at least 5, at least 10, or other suitable number. The coaxial cables may have any suitable size (e.g., a diameter of less than 0.5 mm, less than 0.1 mm, less than 0.05 mm, less than 0.01 mm, and/or other suitable size). A cable formed from a bundle of such coaxial cables may have an overall diameter of any suitable size (e.g., less than 5 mm, less than 1 mm, less than 0.4 mm, less than 0.2 mm, etc.). If desired, wires other than coaxial cables may be included in a cable bundle (e.g., non-coax cables may be included in a bundle of coax cables to handle lower-speed communications such as I²C communications, to carry direct-current power signals, etc.). By using cable bundles containing high-speed signal paths such as coaxial cables, high-bandwidth data such as video captured with the cameras of device 10 and/or the video being displayed by the projectors of device 10 may be conveyed between circuits 104, 108, and 112.

Circuit 108 of FIG. 5 may be located in a central portion of the frame of device 10 and may include strain gauge circuitry (e.g., a strain gauge formed on a flexible printed circuit and/or other strain gauge circuitry such as strain gauge 90 of FIG. 4). The strain gauge may be coupled to a frame member such as frame member 116 (sometimes referred to as a frame structure, metal frame portion, frame portion, etc.) to monitor for deformation of the frame member and therefore possible misalignment of display system components in device 10.

Circuits 104 and 112 may be located on the sides of device 10. Circuit 104 may include circuitry such as circuitry 92 and 98 of FIG. 4. Circuit 112 may include circuitry such as circuitry 70 and 80 of FIG. 4. Signal paths 106 and 110 (e.g., signal lines formed from coaxial cables and/or other wires in cable bundles and/or other cables, metal traces on printed circuits, etc.) may be used in electrically connecting circuits 104, 108, and 112. In this way, power may be routed from batteries 72 and 102 to integrated circuits, sensors, projectors, cameras, strain gauge circuitry, and other powered components, data from sensors may be routed to control circuitry, control signals and other output may be routed from control circuitry to adjustable components (e.g., displays, actuators, speakers, etc.), etc. The signals carried by paths 74 and 78 may include analog and/or digital signals.

Frame member 116 of FIG. 5 may serve as an internal strengthening member in structures 26 that provides structures 26 and device 10 with desired strength and rigidity. Components 114 of FIG. 5 (e.g., circuitry 104, 108, and 112 and signal paths 106 and 110 and frame member 116) may be assembled together when forming device 10. For example, member 116 may have channels that are configured to receive cabling associated with paths 106 and 118.

Polymer and/or other materials forming exterior portions of structures 26 may overlap and/or surround components 114 to help provide environmental protection to these components and to provide the outer surfaces of device 10 with a desired appearance. In an illustrative configuration, polymer may be molded over components 114 to form structures 26.

Internal frame member 116, which may sometimes be referred to as an inner frame, glasses frame member, internal frame member, stiffening member, etc., may be formed from a rigid material such as metal, may be formed from carbon-fiber composite material or other fiber composites (e.g., polymer containing embedded stiffening fibers of glass, carbon, or other fiber materials), may include a stiff polymer, glass, ceramic, etc. In an illustrative configuration, which may sometimes be described herein as an example, frame member 116 may be formed from metal (e.g., aluminum, titanium, steel, magnesium, and/or other elemental metals and/or metal alloys) and may be referred to as a metal frame, metal member, or metal frame member.

Frame member 116 (e.g., a metal frame member) may be machined (e.g., using a computer numerical control tool or other suitable shaping equipment) and/or may be otherwise shaped into a desired final configuration. In the example of FIG. 5, frame member 116 has a top portion (e.g., an elongated metal bar that extends across the width of the glasses frame as described in connection with top portion 50 of FIG. 3) and side portions (e.g., internal support member portions that extend downwards from portion 50 as described in connection with side portions 58 of FIG. 3). Frame member 116 may, if desired, include a central portion with one or more planar surfaces to which a flexible printed circuit substrate containing strain gauge sensor traces may be attached (e.g., surfaces to which a strain gauge in circuit 108 may be mounted).

FIG. 6 is a front view of device 10 after polymer structures and/or other structures have been formed over components 114. As shown in FIG. 6, when components 114 are assembled into device 10, circuit 108 may be located on a central region of member 116 above nose bridge portion 52 of structures 26. To help protect components 114, protective polymer may be used to cover and encapsulate sensitive structures. For example, a protective polymer (e.g., epoxy or other polymer that may be cured at relatively low temperatures) may be used to cover some or all of components 114. As shown in FIG. 6, for example, protective polymer 109 (e.g., epoxy) may be used to encapsulate circuit 108 after circuitry 108 has been mounted to internal frame member 116. Frame member 116 may, if desired, have channels or other features configured to receive cabling associated with paths 106 and 110. Epoxy or other protective polymer may also be used to encapsulate and/or otherwise cover this cabling before subsequent polymers are applied. Ultraviolet light may be applied to the epoxy or other protective polymer to help cure the polymer.

After protecting sensitive structures in components 114 in this way with polymer 109 (sometimes referred to as a protective polymer portion, a thermoset polymer portion, thermoset polymer, a first polymer portion, a first polymer frame portion, etc.), additional polymer layer(s) (sometimes referred to as a thermoplastic polymer portion, a thermoplastic polymer frame portion, a second polymer portion, a second polymer frame portion, a molded polymer portion, molded polymer, an additional polymer portion, etc.) may be applied. For example, one or two or more than two shots of polymer (e.g., thermoplastic polymer) may be injection molded or otherwise formed over components 114 and the protective polymer. This is illustrated by injected-molded polymer 118, which may form frame structures for support structures 26. Polymer 118 may be molded over frame member 116, over the protective polymer such as polymer 109 that is applied to member 116 over circuit 108, and over the protective polymer covering the cabling and/or other circuitry of components 114. As shown in FIG. 6, left and right lens openings may be formed in structures 26 (e.g., in polymer 118) into which lenses 54 (FIG. 3) may be mounted.

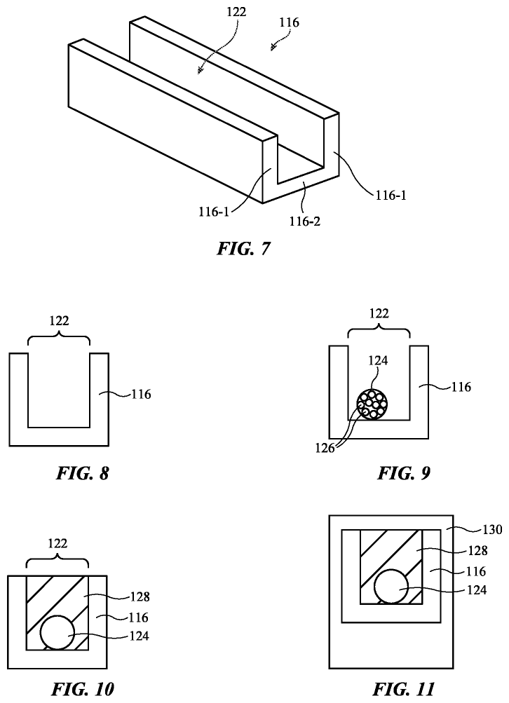

FIG. 7 is a perspective view of a portion of the underside of frame member 116 (e.g., the portion of frame member 116 in region 120 of FIG. 6). As shown in FIG. 7, member 116 may have a lower wall portion 116-2 and sidewall portions 116-1 that are configured to form a signal path recess such as cable channel 122. Cable channel 122 may span the width of device 10 and may receive cabling such as coaxial cable bundles used in forming signal paths 106 and 110 of FIGS. 5 and 6.

FIG. 8 is a cross-sectional view of frame member 116 of FIG. 7 showing the presence of cable channel 112. The C-shaped cross-sectional profile of member 116 may help provide member 116 with strength and rigidity, while also providing routing space to accommodate cable bundle 112. As shown in FIG. 9, coaxial cable bundle 124 may be formed from a bundle of signal lines 126 (e.g., coaxial cables and, if desired non-coaxial-cable wires). Cable bundle (cable) 124 may be inserted into channel 122 before protective polymer 128 (e.g., epoxy) is used to cover and protect cable bundle 124, as shown in FIG. 10. After protective polymer 128 has been used to cover and protect cable bundle 124 (e.g., after cable bundle 124 and/or other cabling associated with signal paths 106 and 110 of FIG. 5 has been embedded within polymer 128 and protected within channel 122), additional polymer (e.g., frame structure polymer such as polymer 118 of FIG. 6) may be molded or otherwise formed over the structures of FIG. 10 (sec, e.g., overmolded polymer 130 of FIG. 11, which surrounds member 116, protective polymer 128, and cable bundle 124). The shape of the frame formed by polymer 130 and the other support structures of device 10 may accommodate lenses 54 with circular outlines, teardrop shapes, aviator lens shapes, oval shapes, rectangular lens shapes, etc. Groves, posts, and/or other engagement features may be formed in polymer 130 (e.g., polymer 118 of FIG. 6) to form mounting structures for lenses 54.

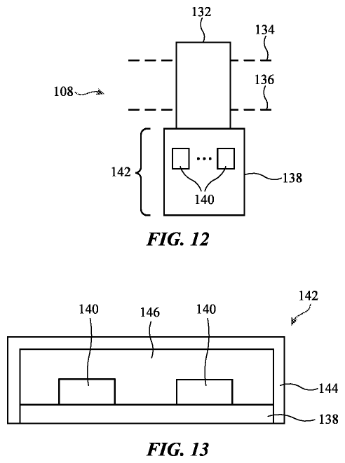

Illustrative strain gauge circuitry that may be used in forming circuit 108 of FIGS. 5 and 6 is shown in FIG. 12. As shown in FIG. 12, circuit 108 may include a flexible printed circuit such as printed circuit 132 that contains one or more sets of strain gauge sensor traces (e.g., meandering metal traces in a bridge circuit that exhibit measurable changes in resistance when bent). Printed circuit 132 may be folded along lines 134 and 136 (e.g., to attach printed circuit 132 and the strain gauge traces of circuit 132 to first and second orthogonal planar surfaces of frame member 116 above nose bridge portion 52). Supporting circuitry 142 for strain gauge operation (e.g., amplifier circuitry, analog-to-digital converter circuitry, etc.) may be formed using one or more integrated circuits 140 on substrate 138. Substrate 138 may be, for example, a rigid printed circuit board or other printed circuit that is attached to printed circuit 132 (e.g., using solder joints, conductive adhesive bonds, or other conductive connections).

If desired, circuitry 142 of FIG. 12 may be formed using a system-in-package arrangement, as shown by the cross-sectional side view of the illustrative system-in-package device of FIG. 13. As shown in FIG. 13, integrated circuits 140 may be solder-bonded or otherwise mounted to printed circuit 138. Encapsulant 146 (e.g., epoxy or other polymer encapsulant) may be used to cover and protect integrated circuits 140. Shielding may then be formed on encapsulant 146. For example, a metal thin-film coating such as thin-film metal coating 144 may be deposited (e.g., by sputter deposition or other deposition techniques) on the top surface and sidewall surfaces of encapsulant 144. In this way, the circuitry of integrated circuits 140 may be provided with electromagnetic interference shielding. A system-in-package device such as the device of FIG. 13 (sometimes referred to as a system-in-package) may be mounted to flexible printed circuit 132 of FIG. 12 and may be used in forming circuit 108.

In some embodiments, sensors may gather personal user information. To ensure that the privacy of users is preserved, all applicable privacy regulations should be met or exceeded and best practices for handling of personal user information should be followed. Users may be permitted to control the use of their personal information in accordance with their preferences.

In accordance with an embodiment, a head-mounted device is provided that includes left and right lenses, a frame having openings for the left and right lenses, the frame includes an elongated metal frame portion with a channel, polymer in the channel, and a cable that extends along the frame, the cable includes a bundle of coaxial cables and is embedded within the polymer in the channel.

In accordance with another embodiment, the frame includes additional polymer that is different than the polymer in the channel, the additional polymer covers at least part of the elongated metal frame portion and covers at least part of the polymer in the channel, and the additional polymer is configured to form the openings.

In accordance with another embodiment, the head-mounted device includes a display projector coupled to the cable.

In accordance with another embodiment, the frame has first and second side portions and has a front portion that includes the elongated metal frame portion and that extends between the first and second side portions.

In accordance with another embodiment, the head-mounted device includes a display projector coupled to the cable, the frame has first and second side portions and has a front portion that includes the elongated metal frame portion and that extends between the first and second side portions.

In accordance with another embodiment, the head-mounted device includes a display projector coupled to the cable.

In accordance with another embodiment, the frame has first and second side portions and has a front portion that includes the elongated metal frame portion and that extends between the first and second side portions.

In accordance with another embodiment, the head-mounted device includes a first projector in the first side portion that is configured to provide a first image, and a second projector in the second side portion that is configured to provide a second image, the first and second projectors are coupled to the cable.

In accordance with another embodiment, the head-mounted device includes a battery in the first side portion that is coupled to the cable.

In accordance with another embodiment, the head-mounted device includes an additional battery in the second side portion that is coupled to the cable.

In accordance with another embodiment, the head-mounted device includes a strain gauge coupled to the cable.

In accordance with another embodiment, the strain gauge is attached to a central portion of the frame.

In accordance with another embodiment, the strain gauge includes strain gauge circuitry in a system-in-package.

In accordance with another embodiment, the system-in-package includes analog-to-digital converter circuitry.

In accordance with another embodiment, the system-in-package includes polymer encapsulant that encapsulates the analog-to-digital converter circuitry and thin-film electromagnetic shielding on the polymer encapsulant.

In accordance with another embodiment, the head-mounted device includes a first circuit in the first side portion that is coupled to the cable, a second circuit in the second side portion that is coupled to the cable, and a third circuit in the front portion that is attached to a central region of the frame, the third circuit is coupled to the cable.

In accordance with another embodiment, the third circuit includes a strain gauge.

In accordance with an embodiment, a head-mounted device is provided that includes a frame having a metal frame portion with a cable channel, left and right lenses coupled to the frame, a bundle of coaxial cables in the cable channel, and polymer in the cable channel, the bundle of coaxial cables is embedded in the polymer.

In accordance with another embodiment, the head-mounted device includes a camera and a projector that are coupled to the bundle of coaxial cables.

In accordance with an embodiment, a head-mounted device is provided that includes a frame having openings for left and right lenses that contain waveguides, the frame has an elongated frame portion with a cable routing recess and has a polymer frame portion that is molded over the elongated frame portion and is configured to form the openings, display projectors configured to supply images to the waveguides, coaxial cabling coupled to the display projectors, and polymer in the cable routing recess that covers the coaxial cabling.

The foregoing is merely illustrative and various modifications can be made to the described embodiments. The foregoing embodiments may be implemented individually or in any combination.

What is claimed is:

1. A head-mounted device, comprising:
left and right lenses;
a frame having openings for the left and right lenses, wherein the frame comprises an elongated metal frame portion with a channel;
polymer in the channel; and
a cable that extends along the frame, wherein the cable comprises a bundle of coaxial cables and is embedded within the polymer in the channel.

2. The head-mounted device defined in claim 1 wherein the frame comprises additional polymer that is different than the polymer in the channel, wherein the additional polymer covers at least part of the elongated metal frame portion and covers at least part of the polymer in the channel, and wherein the additional polymer is configured to form the openings.

3. The head-mounted device defined in claim 2 further comprising a display projector coupled to the cable.

4. The head-mounted device defined in claim 3 wherein the frame has first and second side portions and has a front portion that includes the elongated metal frame portion and that extends between the first and second side portions.

5. The head-mounted device defined in claim 1 further comprising a display projector coupled to the cable, wherein the frame has first and second side portions and has a front portion that includes the elongated metal frame portion and that extends between the first and second side portions.

6. The head-mounted device defined in claim 1 further comprising a display projector coupled to the cable.

7. The head-mounted device defined in claim 1 wherein the frame has first and second side portions and has a front portion that includes the elongated metal frame portion and that extends between the first and second side portions.

8. The head-mounted device defined in claim 7 further comprising:
a first projector in the first side portion that is configured to provide a first image; and
a second projector in the second side portion that is configured to provide a second image, wherein the first and second projectors are coupled to the cable.

9. The head-mounted device defined in claim 8 further comprising a battery in the first side portion that is coupled to the cable.

10. The head-mounted device defined in claim 9 further comprising an additional battery in the second side portion that is coupled to the cable.

11. The head-mounted device defined in claim 10 further comprising a strain gauge coupled to the cable.

12. The head-mounted device defined in claim 11 wherein the strain gauge is attached to a central portion of the frame.

13. The head-mounted device defined in claim 12 wherein the strain gauge comprises strain gauge circuitry in a system-in-package.

14. The head-mounted device defined in claim 13 wherein the system-in-package comprises analog-to-digital converter circuitry.

15. The head-mounted device defined in claim 14 wherein the system-in-package comprises polymer encapsulant that encapsulates the analog-to-digital converter circuitry and thin-film electromagnetic shielding on the polymer encapsulant.

16. The head-mounted device defined in claim 7 further comprising:
a first circuit in the first side portion that is coupled to the cable;
a second circuit in the second side portion that is coupled to the cable; and
a third circuit in the front portion that is attached to a central region of the frame, wherein the third circuit is coupled to the cable.

17. The head-mounted device defined in claim 16 wherein the third circuit comprises a strain gauge.

18. A head-mounted device, comprising:
a frame having a metal frame portion with a cable channel;
left and right lenses coupled to the frame;
a bundle of coaxial cables in the cable channel; and
polymer in the cable channel, wherein the bundle of coaxial cables is embedded in the polymer.

19. The head-mounted device defined in claim 18 further comprising a camera and a projector that are coupled to the bundle of coaxial cables.

20. A head-mounted device, comprising:
a frame having openings for left and right lenses that contain waveguides, wherein the frame has an elongated frame portion with a cable routing recess and has a polymer frame portion that is molded over the elongated frame portion and is configured to form the openings;
display projectors configured to supply images to the waveguides;
coaxial cabling coupled to the display projectors; and
polymer in the cable routing recess that covers the coaxial cabling.
